(19) United States
(12) Patent Application Publication
(10) Pub. No.: US 2017/0089697 A1
(43) Pub. Date: Mar. 30, 2017

(54) IMU BASED HITCH ANGLE SENSING DEVICE

(71) Applicant: Daniel Robert Shepard, Stratham, NH (US)

(72) Inventor: Daniel Robert Shepard, Stratham, NH (US)

(21) Appl. No.: 15/275,386

(22) Filed: Sep. 24, 2016

Related U.S. Application Data
(60) Provisional application No. 62/222,777, filed on Sep. 24, 2015.

(51) Int. Cl. G01B 21/22

(52) U.S. Cl. CPC G01B 21/22; G01C 19/5776

(57) ABSTRACT

The present invention is a hitch angle sensor that utilizes an inertial measurement unit (IMU) in the vehicle and an IMU in the trailer. The present invention measures the rotation of the vehicle and the trailer to determine the change in the angle between the vehicle and the trailer.

### CROSS-REFERENCE TO RELATED APPLICATION

This Patent Application makes reference to and claims the benefit of U.S. Provisional Patent Application 62/222,777 by Shepard titled “IMU BASED HITCH ANGLE SENSING DEVICE” that was filed on Sep. 24, 2015 and that application is incorporated herein in its entirety by reference in its entirety; this Patent Application also makes reference to U.S. Pat. No. 7,715,953 (the '953 patent) by Shepard titled “TRAILER BACKING UP DEVICE AND METHOD” which issued on May 11, 2010 and U.S. Pat. No. 9,132,856 (the '856 patent) by Shepard titled “TRAILER BACKING UP DEVICE AND TABLE BASED METHOD” that issued on Sep. 15, 2015 and those patents are incorporated herein by reference in their entirety.

### FIELD OF THE INVENTION

In various embodiments, the present invention relates to the measurement of the articulation angle between a vehicle and a trailer, also known as the hitch angle, and in particular relates to the measurement of the hitch angle by measuring the combined rotation of the vehicle and the rotation of the trailer.

### REFERENCE TO A SEQUENCE LISTING, A TABLE, OR A COMPUTER PROGRAM LISTING COMPACT DISK APPENDIX

Not Applicable.

### CROSS REFERENCE TO RELATED APPLICATIONS

Not Applicable.

### REFERENCE REGARDING FEDERAL SPONSORSHIP

Not Applicable.

### STATEMENT REGARDING FEDERALLY SPONSORED RESEARCH OR DEVELOPMENT

Not Applicable.

### SUMMARY OF THE INVENTION

Trailering systems often require knowing the articulation angle between a vehicle and a trailer, also known as the hitch angle. Prior art reveals various ways to measure the hitch angle. The simplest solutions address parts of the problem ranging from ways of sensing the angle of the hitch (see: Kollitz, U.S. Pat. No. 4,122,390), to sensing and displaying the angle of the hitch (see: Gavit, U.S. Pat. No. 3,833,928), to sounding an alarm when a jackknife condition exists or is imminent (see: Kimmel, U.S. Pat. No. 4,040,006). Other prior art sensors have used potentiometers to create a variable resistance proportional to the hitch angle. Still others have applied a patterned pictogram to the trailer that can me viewed by a rear view camera (typically used for seeing behind the vehicle when backing up) and, using video processing and pattern recognition routines, can calculate the hitch angle. However, the latter imaging based systems are susceptible to problems if the pictogram should be damaged, soiled or removed. The present invention is an alternate means for a hitch angle measuring device that does not suffer from these problems.

In creating such a hitch angle measuring device, the sensor must be designed not to be damaged either during hitching up a trailer (due to a collision between the hitch and sensor with a part of the trailer) nor while towing on the highway (due to kicked up debris). It must also be very low cost. The present invention is a hitch angle sensor that addresses these needs.

### BRIEF DESCRIPTION OF THE DRAWINGS

FIG. 1 depicts an articulated hitch connection.

FIG. 2 depicts a 6 Degree of Freedom (6 DoF) Inertial Measurement Unit (IMU).

FIG. 3 depicts a vehicle and a trailer where both the vehicle and the trailer have an IMU.

FIG. 4 depicts an example of the angles for the rotation math.

### DESCRIPTION OF THE PREFERRED EMBODIMENT

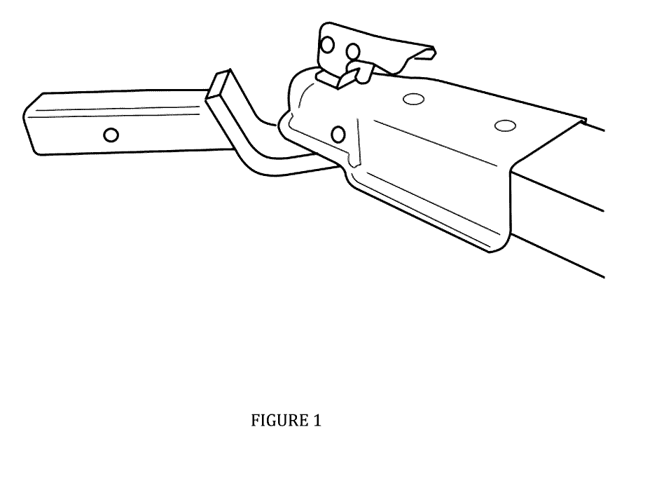

When a vehicle is towing a trailer, the two are typically connected by way of a hitch ball and trailer tongue with a coupler (see FIG. 1). As the vehicle moves, depending on the direction of the vehicle, the angle of the connection between the vehicle and the trailer will typically change.

An electronic sensor can be constructed that measures this angle between the vehicle and trailer. This sensor must be designed not to be damaged either during hitching up a trailer (due to a collision between the hitch and sensor with a part of the trailer) nor while towing on the highway (due to kicked up debris). In the prior art, this has been accomplished by incorporating means to armor the hitch sensor such that it is not below the hitch ball where it would be most vulnerable to being struck by kicked up debris while traveling on the highway. This is further accomplished by enabling the sensor to be positioned away from the hitch ball when hitching up a trailer, thereby avoiding damage by having the trailer tongue collide with the sensor during hitch-up.

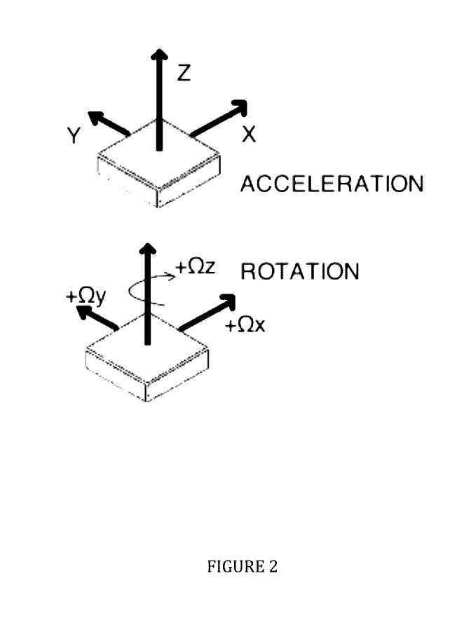

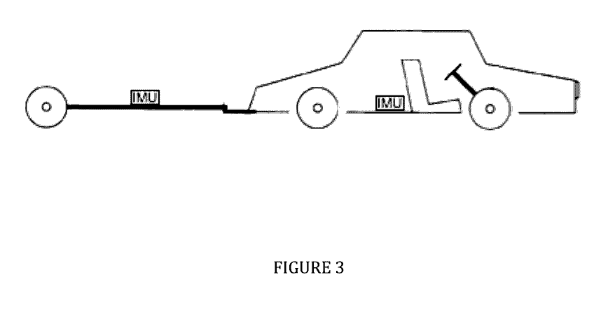

The present invention is a system that utilizes two inertial measurement units (IMU's). An example of an IMU device is the “iNEMO inertial module always-on 3D accelerometer and 3D gyroscope”, part number LSM6DS3 from STMicroelectronics. These IMU's can each be interfaced to a computing device such as a microcomputer and each computing device may have communications capability. One IMU is fixed to the vehicle and one is fixed to the trailer (see FIG. 3). These two IMU's can be connected, using wires or wirelessly, to a central computing device. The central computing device receives data from the two IMU's corresponding to the position of each IMU in three dimensional space. A typical IMU (see FIG. 2) can comprise gyroscopes and accelerometers, often three of each for measuring rotation about the x, y, and z axis (gyroscopes) and acceleration in the x, y, and z direction (accelerometers)—this would be a 6 degree of freedom (6 DoF) IMU device. However, for greater accuracy, 9 DoF is preferred and is provided by adding a magnetometer to additionally measure a magnetic field in the x, y, and z directions. Extra degrees of freedom are desirable to correct for errors that can otherwise accumulate in the data integration. For example, an IMU from InvenSense, part number MPU-9250, is a 9 DoF device and this device further comprises an internal processor which can be loaded with library functions provided by InvenSense that performs the data collection and integration of data readings to track rotation about the x, y, and z axes and motion in the x, y, and z directions and will provide quaternion data. (For a background reference, see https://en.wikipedia.org/wiki/Quaternions_and_spatial_rotation)

The trailer's IMU would have a cable to provide power and, optionally on versions not using wireless, wired communications. Power for the trailer IMU is provided from the vehicle through connections to the wiring harness that is already present on most hitch assemblies to provide power to the trailer for such purposes as tail lights, break lights, automatic breaking systems, and the like. Alternatively, power could be provided by incorporating batteries into the sensor assembly, but this may require the extra operator intervention of switching the circuits on or off. The sensor output is provided to monitoring systems in the vehicle by way of an additional wire incorporated into that same wiring harness or by such commercially available wireless connections as WiFi or Bluetooth. Alternatively, a separate cable to provide power and communications between the sensor and a system in the vehicle could be used. Alternatively, a separate cable to provide just communications between the sensor and a system in the vehicle could be used if power could separately be obtained through the wiring harness. Alternatively, a modulated carrier signal carrying the data information can be injected onto the wiring in the trailer such that this modulated signal will travel to the vehicle via the trailer wiring harness where it can be detected and demodulated for the vehicle based system to retrieve the data.

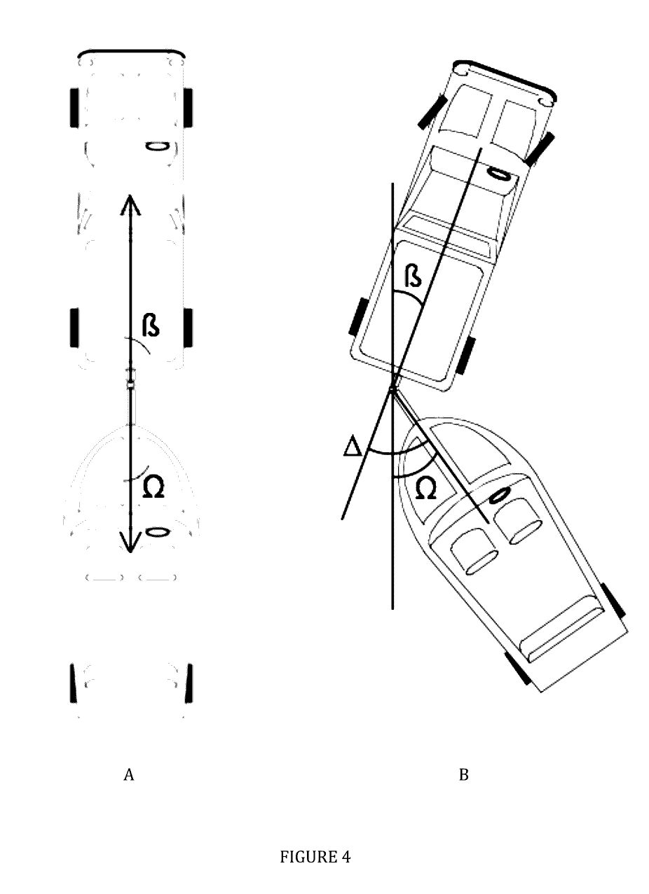

The system is initialized when the vehicle and trailer are motionless and in a straight line. This is initiated by having the vehicle operator drive forward on a level surface until the vehicle and trailer are in a straight line. Once in a straight line, the operator stops the vehicle and presses a button that is connected to the system. This button signals the system to read the data values from the IMU. (Alternatively, an additional sensor could detect when the vehicle and the trailer are in a straight line and signal the system to read the data values from the IMU.) With these data values, as is well known to those skilled in the operation of IMU's and software programming of systems that use IMU's, the orientation of these IMU's can be determined relative to these initial values (for a detailed write-up on IMU programming, see the internet URL http://www.instructables.com/id/Accelerometer-Gyro-Tutorial/?ALLSTEPS). Generally speaking, this is done by using the knowledge that with the vehicle stopped, the only acceleration that will be sensed by the accelerometers is gravity. This gives the reference orientation of the two IMU's and, more particularly, the orientation of the vehicle to the trailer. These IMU data values are the zero reference values and they corresponding to the vehicle and trailer being in a straight line and stopped (i.e., the zero reference position). At ‘A’ in FIG. 4, an example initialization is depicted in which B represents the initial (zeroed) rotation of the vehicle and Ω represents the initial (zeroed) rotation of the trailer and the vertical line drawn through the picture represents the initialized position.

At ‘B’ in FIG. 4, following initialization, as the vehicle moves, the gyroscopes in the two IMU's will indicate rotation about the x, y, and z axis (where the z axis is parallel to the force direction of gravity determined during initialization). Typically, the IMU will be mounted in the vehicle and trailer with their z axis pointing upwards (however, if not oriented this way, the axis of the IMU's can be translated into the real world coordinate axis system with the z axis in the vertical direction using mathematical transforms to define the gravity vector to be the vertical z axis, as is well understood by those skilled in the art). Rotation about the z axis measured by the vehicle based IMU corresponds to the turning of the vehicle (i.e., a change in direction of the vehicle) whereas rotation about the z axis measured by the trailer based IMU corresponds to the turning of the trailer (i.e., a change in direction of the trailer). Note that since the vehicle rotates as a single entity, the IMU can be positioned anywhere on or in the vehicle to measure its rotation, and that since the trailer likewise rotates as a single entity, its IMU can be positioned anywhere on or in the trailer to measure its rotation. For the sake of the present teaching, the sign of the rotation is defined to be positive for (i) clockwise rotation of the vehicle and (ii) counter-clockwise rotation of the trailer. By adding the change in direction of the vehicle (measured from the vehicle's zero reference position direction) to the change in direction of the trailer (measured from the trailer's zero reference position direction), the hitch angle is obtained (typically using a computing device to mathematically calculate the hitch angle from the measured values of rotation of the vehicle and the trailer). By way of the example at ‘B’ in FIG. 4, if following initialization (represented by the vertical line through the picture) the vehicle's rotation is 15 degrees clockwise from its initialized position (i.e., β=+15°) and the trailer's rotation is 20 degrees counter-clockwise from its initialized position (i.e., Ω=+20°), the angle of articulation, or hitch angle, Δ, is 35 degrees (Δ=β+Ω or numerically Ω=+15°++20°=+35°).

Variations on the present invention include using alternate coordinate axes for the vehicle and/or trailer rotation. For example, if the trailer rotation were signed oppositely, (i.e., if clockwise trailer rotation were positively signed), the math would have to be adjusted to subtract (instead of add) the trailer's rotation from the vehicle's rotation (Δ=β−Ω). By way of the example at ‘B’ in FIG. 4, if following initialization the vehicle's rotation is 15 degrees clockwise (i.e., β=+15°) and the trailer's rotation is 20 degrees counter-clockwise (i.e., Ω=−20°), the angle of articulation, or hitch angle, Δ, is 35 degrees (Δ=β−Ω or numerically Δ=+15°−−20°=+35°).

Another variation on the present invention is to utilize the accelerometer of either or both IMU's to measure distance along the circumference of a circle formed by the rotation. For example, if an IMU is mounted on the trailer and the distance from the hitch ball to the IMU is known (i.e., the radius of a circle is defined by its center of rotation—which is at the hitch ball—and its radius—which is the distance, D, from the hitch ball to the IMU on the trailer), the data from the x and y accelerometers could be integrated to determine the distance along the perimeter of the circle formed by the trailer rotating (∫p). Since the total circumference is determined by 2πD, the angle rotated (in degrees) would be 360 times the portion of the circle rotated, or: 360*(∫p)/2πD. Such a variation will be well understood to those skilled in the art of IMU's in light of the present teaching.

The present invention can be used with any vehicle (e.g., cars, trucks, hauling cabs, etc.) and trailer (e.g., boat trailers, 5^{th} wheel campers, steerable trailers, tractor trailer trailers, etc.). Because the vehicle and the trailer move, generally, over level ground (i.e., in the x-y plane) the axis of rotation about which both the vehicle and the trailer rotate is the vertical ‘z’ axis which corresponds to the gravity vector. An adjustment can be made if the ground is not level to account for the axis of rotation not being aligned to the gravity vector, but the error is not typically noticeable if the incline is not large; in a backup system such as the one described in the '953 or '856 patents, since the human operator is ‘eye-balling’ the direction to steer, this human feedback will typically compensate for an error due to the ground not being perfectly level. The present invention can be used wherever an angular measurement is required (albeit, if the axis of rotation is far from parallel to the gravity vector, a transformation or other adjustment would be required to measure rotation about the actual axis of rotation).

The foregoing description of an example of the preferred embodiment of the invention and the variations thereon have been presented for the purposes of illustration and description. It is not intended to be exhaustive or to limit the invention to the precise forms disclosed. Many modifications and variations are possible in light of the above teaching. It is intended that the scope of the invention be limited not by this detailed description, but rather by any claims appended hereto.

I claim:

1. A trailer hitch angle sensing system comprising a rotation sensor in a vehicle and a rotation sensor in a trailer whereby the rotation of the vehicle and the trailer are measured and the hitch angle is determined from the two rotation measurements.

2. The trailer hitch angle sensing system of claim 1 whereby the rotation sensor in the trailer comprises one or more electric components.

3. The trailer hitch angle sensor of claim 2 whereby the one or more electric components receive power from a battery.

4. The trailer hitch angle sensor of claim 2 whereby the one or more electric components receive power from the vehicle.

5. The trailer hitch angle sensing system of claim 4 whereby receiving power comprises a connection through a standard trailer wiring harness that provides power to the trailer.

6. The trailer hitch angle sensor of claim 1 further comprising a communication device.

7. The trailer hitch angle sensor of claim 6 whereby output from the communication device is provided to the vehicle by means of a wired connection.

8. The trailer hitch angle sensor of claim 7 whereby the wired connection comprises a carrier signal traveling over one of the wires of the wiring harness.

9. The trailer hitch angle sensor of claim 6 whereby output from the communication device is provided to the vehicle by means of a wireless connection.

10. The trailer hitch angle sensor of claim 9 whereby the wireless connection is a Bluetooth connection.

11. The trailer hitch angle sensing system of claim 6 further comprising a computing device that can receive information from the rotation sensor and provide information to the communication device.

12. A method for detecting an angle between a vehicle and a trailer that are coupled together comprising the steps of: (i) providing a first sensor in the vehicle that can sense a position or motion in space, (ii) providing a second sensor in the trailer that can sense a position or motion in space, (iii) using the first sensor to determine a rotation value for the vehicle, (iv) using the second sensor to determine a rotation value for the trailer, and (v) using a computing device to determine the angle between the vehicle and the trailer from the measured rotation values for the vehicle and the trailer.

13. The method for detecting an angle between a vehicle and a trailer that are coupled together of claim 12 further comprising the steps of: (i) signaling the computing device, (ii) capturing the orientation of the vehicle at approximately the time of the signal, (iii) capturing the orientation of the trailer at approximately the time of the signal, and (iv) using the captured orientation of the vehicle and the captured orientation of the trailer as a reference point for determining the angle between the vehicle and the trailer.

14. The method for detecting an angle between a vehicle and a trailer that are coupled together of claim 13 whereby signaling the computing device comprises an action by an operator to affect signaling the computing device.

15. The method for detecting an angle between a vehicle and a trailer that are coupled together of claim 13 whereby signaling the computing device comprises an output from a sensor to affect signaling the computing device.

16. A device for measuring an angle comprising a first and second structure joined by a joint having a center of rotation, a first rotation sensor on the first structure, and a second rotation sensor on the second structure, whereby the axes of rotation of the first and second rotation sensor are generally parallel to the axis of rotation of the joint, whereby a rotation value for the first structure is measured by the first rotation sensor, whereby a rotation value for the second structure is measured by the second rotation sensor, whereby the angle between the first and second structure is determined by mathematically combining the first and second value.

17. The device of claim 16 whereby one or both of the first and second rotation sensors is an inertial rotation sensor.

18. The device of claim 16 whereby mathematically combining comprises addition or subtraction.

19. The device of claim 16 whereby the rotation value measured by the rotation sensors is measured relative to a reference position.

20. The device of claim 19 whereby the reference position is initialized prior to measuring to determine the angle between the first and second structure.
